(19) United States
(12) Patent Application Publication
(10) Pub. No.: US 2026/0329296 A1
(43) Pub. Date: Oct. 22, 2026

(54) METHOD FOR REAL-TIME OBSTACLE AVOIDANCE IN UNMANNED AERIAL VEHICLES

(71) Applicant: Richard Joseph Mitchell, TAVARES, FL (US)

(72) Inventor: Richard Joseph Mitchell, TAVARES, FL (US)

(21) Appl. No.: 19/376,974

(22) Filed: Nov. 2, 2025

(51) Int. Cl. G05D 1/644; G05B 17/02; G05D 1/246; G05D 1/622; G05D 109/20; G08G 5/30; G08G 5/80

(52) U.S. Cl. CPC G05D 1/644; G05B 17/02; G05D 1/2465; G05D 1/622; G08G 5/30; G08G 5/80; G05D 2109/20

(57) ABSTRACT

A method for real-time obstacle avoidance in an unmanned aerial vehicle (UAV) is disclosed. The method involves receiving an environmental model of the UAV's surroundings and identifying a potential obstacle. In response, a path generation algorithm, such as a rapidly-exploring random tree (RRT), generates multiple distinct, candidate alternative flight paths that avoid the obstacle. A composite cost score is calculated for each candidate path. This score is a function of multiple factors, such as the path's additional length, time delay, and energy consumption. The weights of these factors can be dynamically adjusted based on real-time mission parameters like battery life or urgency. The candidate path with the most favorable cost score is selected as the optimal path, and the UAV is commanded to follow it. This allows for intelligent, adaptive, and efficient navigation around obstacles.

### CROSS-REFERENCE TO RELATED APPLICATIONS

This application is related to co-pending U.S. Patent Application titled ‘REDUNDANT CONTROL ARCHITECTURE FOR MULTI-DOMAIN AUTONOMOUS AGENTS’, filed on Oct. 28, 2025, the entire disclosure of which is incorporated herein by reference.

### BACKGROUND OF THE INVENTION

The present invention relates to methods for autonomously navigating unmanned aerial vehicles (UAVs). Specifically, the invention pertains to a computational method for processing sensor data to generate and select an optimal collision-free flight path in real-time.

The proliferation of autonomous UAVs in commercial and civilian airspace has created an urgent need for robust and reliable sense-and-avoid capabilities. The ability of a UAV to detect and react to unexpected obstacles is paramount for safe operation. Many existing methods for obstacle avoidance rely on reactive algorithms that trigger a predefined maneuver, such as stopping or ascending, upon detection of an object within a certain proximity. These reactive methods are computationally simple but lack foresight and efficiency. They do not account for the dynamics of the obstacle or the broader context of the UAV's mission, often resulting in jerky, inefficient flight that consumes significant time and energy.

More advanced methods attempt to plan alternative paths around obstacles. However, these methods often face a trade-off between computational complexity and optimality. For example, some path-planning algorithms, while capable of finding a theoretically optimal path, are too computationally intensive to be executed in real-time on the limited processing hardware available on many UAVs. They may require the UAV to pause its mission while a new path is computed, which is not viable for time-sensitive applications or for avoiding fast-moving obstacles. Other methods that are faster may generate suboptimal paths that are safe but highly inefficient.

A key deficiency in the prior art is the lack of a method that can, in real-time, generate a set of multiple, viable, collision-free flight paths and then select the most optimal path from that set based on a dynamic, mission-aware cost analysis. Therefore, a need exists for a computationally efficient method that bridges the gap between simple reactive maneuvers and computationally expensive optimal planning.

### BRIEF SUMMARY OF THE INVENTION

The present invention provides a method for real-time obstacle avoidance that addresses the shortcomings of the prior art. The method involves generating a plurality of candidate flight paths in response to a detected obstacle and selecting the optimal path from this candidate set using a multi-factor cost assessment. This approach allows for a computationally efficient yet highly effective means of dynamic navigation.

In one embodiment, a method for real-time obstacle avoidance in an unmanned aerial vehicle is provided. The method comprises receiving a unified environmental model representing an area around the UAV. An obstacle is identified within the model, and its trajectory is predicted. In response, a path generation algorithm generates a plurality of distinct, candidate alternative flight paths, each configured to avoid a collision with the obstacle. For each candidate path, a composite cost score is calculated. This score is a function of at least three factors: a path length cost, a temporal cost, and an energy cost associated with that path. The method then selects the candidate alternative flight path having the most favorable composite cost score and directs the UAV to follow the selected path.

In another embodiment, the path generation algorithm is a rapidly-exploring random tree (RRT) algorithm that is biased toward the UAV's original destination. This allows for the rapid generation of multiple, diverse, and viable avoidance paths.

In a further embodiment, the calculation of the composite cost score is dynamically weighted. The weights assigned to the path length cost, temporal cost, and energy cost are adjusted based on real-time mission parameters, such as remaining battery life or mission urgency. This allows the avoidance strategy to adapt to the changing context of the mission.

### BRIEF DESCRIPTION OF THE SEVERAL VIEWS OF THE DRAWING

FIG. 1 is a flowchart illustrating the overall process of the real-time obstacle avoidance method in accordance with an embodiment of the invention.

FIG. 2 is a schematic diagram illustrating the generation of multiple candidate alternative flight paths around a detected obstacle.

FIG. 3 is a conceptual diagram illustrating the calculation of a composite cost score for a candidate flight path based on multiple cost factors.

### DETAILED DESCRIPTION OF THE INVENTION

The present invention is a computational method for enabling an unmanned aerial vehicle (UAV) to navigate safely and efficiently in dynamic environments. The method is typically implemented as software instructions executed by one or more processors within a UAV's onboard control system.

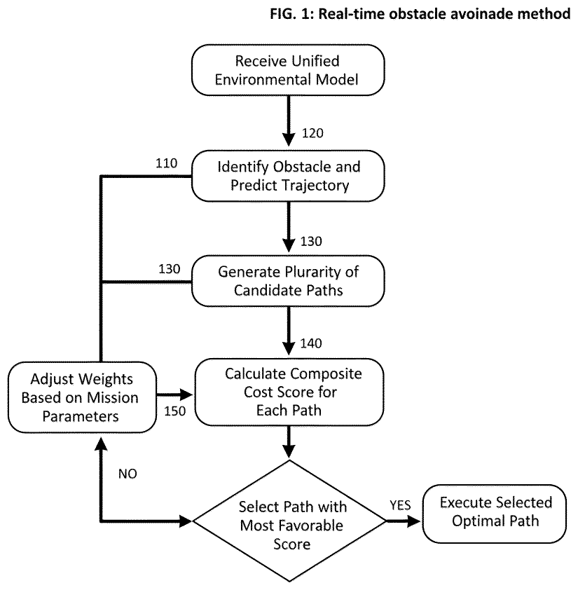

Turning to FIG. 1, a flowchart illustrates the steps of the method (100). The method begins at step (110), where the control system receives a unified environmental model. This model, which may be generated by a data fusion process as described in co-pending Application titled ‘REDUNDANT CONTROL ARCHITECTURE FOR MULTI-DOMAIN AUTONOMOUS AGENTS’, provides a comprehensive representation of the UAV's surroundings, including the location and velocity of nearby objects.

At step 120, the method involves analyzing the unified environmental model to identify an obstacle and predict its trajectory. This step identifies objects that pose a potential collision risk to the UAV based on its current flight plan.

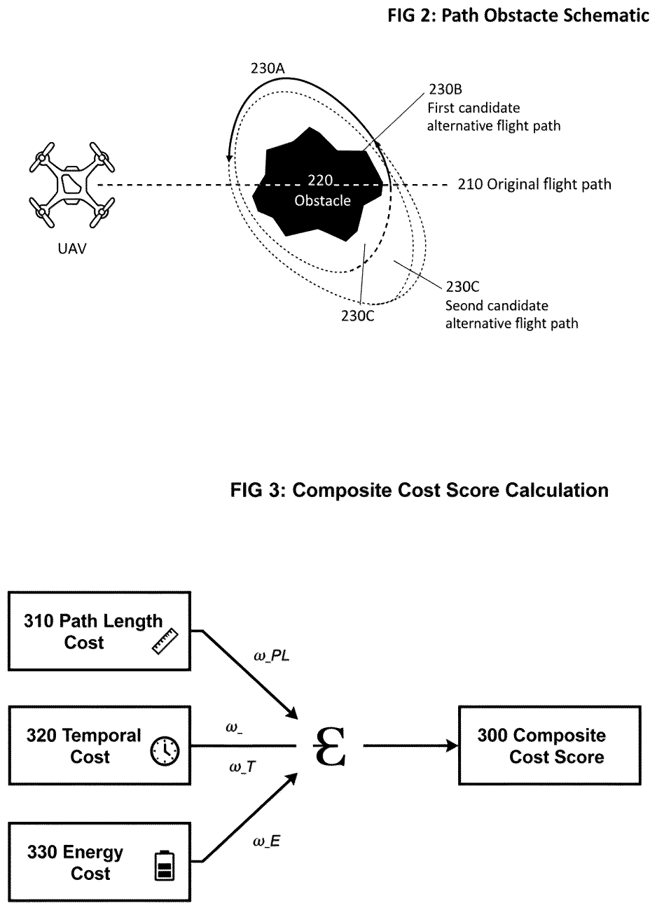

In response to identifying a potential collision, the method proceeds to step (130), where a path generation algorithm is executed to generate a plurality of candidate alternative flight paths. As shown in FIG. 2, a UAV (200) following an original flight path (210) detects an obstacle (220). The path generation algorithm then generates a set of distinct candidate paths, such as path (230A), path (230B), and path (230C), each of which provides a collision-free route around the obstacle (220). In a preferred embodiment, the path generation algorithm is a variant of the rapidly-exploring random tree (RRT) algorithm. The RRT algorithm is computationally efficient and well-suited for finding paths in complex spaces. The algorithm can be biased to grow the “tree” of possible paths in the general direction of the UAV's ultimate destination, ensuring that the generated candidate paths are not only safe but also goal-oriented.

Returning to FIG. 1, once the set of candidate paths is generated, the method proceeds to step (140), where a composite cost score is calculated for each candidate alternative flight path. This step is central to the inventive method and allows for an intelligent selection among the various safe options.

As illustrated conceptually in FIG. 3, the composite cost score (300) for a given candidate path is a function of at least three distinct cost factors. The first is a path length cost (310), which represents the additional distance the UAV must travel compared to the original flight plan. The second is a temporal cost (320), representing the estimated delay in reaching the destination. The third is an energy cost (330), representing the additional battery power required to execute the maneuvers of the candidate path (e.g., sharp turns or rapid changes in altitude consume more energy). These individual cost factors are combined, for example through a weighted sum, to produce the single composite cost score (300).

In a particularly advantageous embodiment, the weights used to calculate the composite cost score are dynamic. At step (150) of FIG. 1, the method adjusts the weights based on current mission parameters. For example, if the UAV's remaining battery life is critically low, the weight for the energy cost (330) would be increased, causing the system to favor paths that are more energy-efficient, even if they are slightly longer or slower. Conversely, for a time-critical mission, such as delivering emergency medical supplies, the weight for the temporal cost (320) would be increased, prioritizing the fastest possible route⁶⁰. In another embodiment, the mission parameter may be a communication signal strength. For instance, if the UAV's control or data link signal strength becomes low, the system may dynamically increase the weight associated with the path length cost (310) or a related proximity cost, favoring a candidate path that keeps the UAV closer to a base station or avoids geographic features known to obstruct signals. This ensures that the avoidance maneuver itself does not jeopardize the UAV's command and control link.

At step (160), the method selects the candidate alternative flight path that has the most favorable composite cost score (e.g., the lowest score). This selected path represents the optimal balance of safety, efficiency, and mission objectives at that moment.

Finally, at step (170), the method concludes by generating and transmitting flight control commands to the UAV's propulsion system to execute the selected optimal path. The entire method (100) is executed iteratively and in real-time, allowing the UAV to continuously adapt its path in response to a changing environment.

What is claimed is:

1. A method for real-time obstacle avoidance in an unmanned aerial vehicle (UAV), the method performed by one or more processors and comprising:
receiving a unified environmental model representing a three-dimensional space surrounding the UAV;
identifying, from the unified environmental model, an obstacle posing a potential collision risk with a current flight path of the UAV;
in response to identifying the obstacle, executing a path generation algorithm to generate a plurality of distinct candidate alternative flight paths, each candidate alternative flight path providing a collision-free trajectory around the obstacle;
for each of the plurality of candidate alternative flight paths, calculating a composite cost score, wherein the composite cost score is a function of at least a path length cost, a temporal cost, and an energy cost associated with the respective candidate alternative flight path;
selecting, from the plurality of candidate alternative flight paths, an optimal alternative flight path having a most favorable composite cost score; and
generating flight commands to direct the UAV to follow the selected optimal alternative flight path.

2. The method of claim 1, wherein the path generation algorithm is a rapidly-exploring random tree (RRT) algorithm.

3. The method of claim 2, wherein the RRT algorithm is biased to generate candidate alternative flight paths directed toward a destination of the current flight path.

4. The method of claim 1, wherein calculating the composite cost score comprises calculating a weighted sum of the path length cost, the temporal cost, and the energy cost.

5. The method of claim 4, further comprising:
receiving a mission parameter indicative of a current state of the UAV's mission; and
adjusting one or more weights of the weighted sum based on the received mission parameter.

6. The method of claim 5, wherein the mission parameter is a remaining battery life of the UAV, and wherein adjusting the one or more weights comprises increasing a weight corresponding to the energy cost when the remaining battery life is below a predetermined threshold.

7. The method of claim 5, wherein the mission parameter is a mission urgency indicator, and wherein adjusting the one or more weights comprises increasing a weight corresponding to the temporal cost when the mission urgency indicator is active.

8. The method of claim 1, further comprising predicting a future trajectory of the obstacle, wherein the plurality of candidate alternative flight paths are generated to avoid the predicted future trajectory.

9. A control system for an unmanned aerial vehicle (UAV), comprising:
one or more processors; and
a memory storing instructions that, when executed by the one or more processors, cause the system to perform a method for real-time obstacle avoidance, the method comprising:
receiving a unified environmental model representing a three-dimensional space surrounding the UAV;
identifying, from the unified environmental model, an obstacle posing a potential collision risk with a current flight path of the UAV;
in response to identifying the obstacle, executing a path generation algorithm to generate a plurality of distinct candidate alternative flight paths, each providing a collision-free trajectory around the obstacle;
for each of the plurality of candidate alternative flight paths, calculating a composite cost score as a weighted function of a path length cost, a temporal cost, and an energy cost;
dynamically adjusting one or more weights of the weighted function based on a real-time mission parameter;
selecting an optimal alternative flight path from the plurality of candidate alternative flight paths based on the calculated composite cost scores; and
generating flight commands to direct the UAV to follow the selected optimal alternative flight path.

10. The system of claim 9, wherein the path generation algorithm is a rapidly-exploring random tree (RRT) algorithm biased toward a destination of the current flight path.

11. The system of claim 9, wherein the real-time mission parameter is selected from the group consisting of a remaining battery life, a mission urgency indicator, and a communication signal strength.

12. The system of claim 9, wherein the method further comprises predicting a future trajectory of the obstacle, and wherein the candidate alternative flight paths are generated to avoid the predicted future trajectory.
